(19) United States
(12) Patent Application Publication
(10) Pub. No.: US 2019/0293576 A1
(43) Pub. Date: Sep. 26, 2019

(54) SAMPLE HOLDER FOR ANALYZING SOLID FORM PROPERTIES OF A SUBSTANCE

(71) Applicant: HOFFMANN-LA ROCHE INC., Little Falls, NJ (US)

(72) Inventors: Urs SCHWITTER, Reinach (CH); Frédéric RAN, Kembs (FR); André ALKER, Weil am Rhein (DE); Tom KISSLING, Riehen (CH); Thomas ZUMSTEIN, Weil am Rhein (DE)

(73) Assignee: HOFFMANN-LA ROCHE INC., Little Falls, NJ (US)

(21) Appl. No.: 16/345,218

(22) PCT Filed: Oct. 27, 2017
(86) PCT No.: PCT/EP2017/077646

§ 371 Date: Apr. 25, 2019

(30) Foreign Application Priority Data
Oct. 28, 2016 (EP) 16196163.6

(51) Int. Cl. G01N 23/20025; B01L 3/00

(52) U.S. Cl. CPC G01N 23/20025; B01L 2300/0829; B01L 3/50

(57) ABSTRACT

A sample holder (1) for containing a substance in a solid form screening process comprises a body (2) with a sidewall portion (21), a bottom portion (22) and a hollow interior limited by the sidewall portion (21) and the bottom portion (22). The bottom portion (22) is made of a thermoplastic polyimide. The sample holder (1) allows for providing a high quality analysis of solid form properties of a substance and an efficient and safe processing of the substance.

### TECHNICAL FIELD

The present invention relates to a sample holder according to the preamble of independent claim 1 and more particularly to a method of manufacturing such a sample holder. Such sample holders comprising a body with a sidewall portion, a bottom portion and a hollow interior limited by the sidewall portion and the bottom portion can be used for containing a substance in a solid form or polymorphism screening process.

### BACKGROUND ART

In chemical, biochemical and pharmaceutical research and development, various product developing or manufacturing processes involve, at a certain stage, the creation of a substance in a solid form such as a crystallized form. Thereby, it often is highly relevant that the structure and condition of the solid form meets specific requirements. For that purpose, many development and particularly research processes include polymorphism screening in which solid form properties of substances are analyzed.

For analyzing the solid form properties, e.g., in a solid form or polymorphism screening process, X-ray diffractometry (XRD) and X-ray powder diffractometry (XRPD) are known and often preferred methods to apply. In this context, the term “solid form properties” can relate to any feature characteristic for the preparation of the solid substance. For example, such properties may include crystallinity, chemical structure, solid form or the like. Thereby, the substance or a powder thereof having a solid structure is irradiated with X-ray. The powder diffracts the X-ray similar to a diffraction grid and maxima of the diffracted X-ray is scanned with a detector. The location and intensity of the maxima are representative for the solid structure of the powder or substance.

Furthermore, in development and research, substances typically are provided and processed in standardized multi-well microtiter plates. When using such a microtiter plate for processing a substance, it is usually arranged inside a well of the microtiter plate. For applying XRD or XRPD in X-ray reflection geometry to the substance in the well X-ray is typically provided top down into the well, reflected in the well or at a bottom thereof and measured by a detector after reflection, typically above the well. Thereby, it often is quite cumbersome to evaluate the reflected X-ray since it may be affected by preferred orientation effects, sample displacement/transparency error and other errors that can negatively influence peak positions/intensity and peak shape.

Furthermore, for being capable to process highly active substances and damageable substances inside the wells the microtiter plate has to be specifically embodied. For example, it is known to coat the microtiter plates or at least the inside of the wells thereof with polytetrafluoroethylene (PTFE or Teflon). Like this, unintended reactions of the substances within the microtiter plate itself can be prevented or reduced. However, PTFE-coatings are comparably soft such that they can comparably easily be scratched and damaged. Furthermore, manufacturing such microtiter plates is comparably cost intensive and damaged microtiter plates usually have to be disposed.

Still further, substances are typically also processed outside the microtiter plate since not all steps of usual processes can be performed when the substance is inside the well of the microtiter plate. For that purpose, the substance has to be transferred to another containment or place. Such transfer can be comparably cumbersome and dangerous. For example, at the end of many processes substances are often stored in specific storage microtiter plates wherein they have to be transferred and rearranged from one microtiter plate into another microtiter plate.

Therefore, there is a need for a durable and cost efficient system allowing a high quality analysis of solid form properties of a substance and an efficient and safe processing of the substance.

### DISCLOSURE OF THE INVENTION

According to the invention this need is settled by a sample holder as it is defined by the features of independent claim 1, by a multi-well plate as it is defined by the features of independent claim 14 and by a method of analyzing solid form properties of a substance as it is defined by the features of independent claim 15. Preferred embodiments are subject of the dependent claims.

In particular, the invention deals with a sample holder for containing a substance in a solid form or polymorphism screening process. The sample holder comprises a body with a sidewall portion, a bottom portion and a hollow interior limited by the sidewall portion and the bottom portion. The bottom portion is made of a thermoplastic polyimide (TPI). Thereby, the TPI is at least partially amorphous and can particularly be completely amorphous. Preferably, the sidewall portion and the bottom portion are one single piece made of the TPI.

The term “sample” as used herein can relate to a limited quantity of the substance which is intended to be similar to and represent a larger amount of it. Even though this term often is understood to be a smaller quantity taken from a larger quantity also full specimens can be called samples, e.g., if taken for analysis, testing, or investigation like other samples.

The substance can be a chemical, biological, pharmaceutical or bio-chemical substance. For example, it can be a drug, drug candidate or a component of a drug. In particular, the substance can be a chemically, biologically or biochemically active or highly active substance. Thereby, the term “biologically active substance” can refer to a substance or sample that has a beneficial or adverse effect on the metabolic activity of living cells.

Such substances often are toxic or even highly toxic at a certain dosage or, at least, it can be undesired to expose persons to the substance even to very small amounts thereof. Thus, it often is necessary to protect an environment around the substance, e.g., by containing it in a tight compartment.

The term “holder” as used herein can relate to any structure suitable for holding or carrying the sample. It can, e.g., be a micro-vessel. The term “micro” in connection with the vessel relates to a dimension of the vessel suitable for carrying a sufficient amount or a sample of the substance for performing any desired testing, analysis, inspection, investigation, demonstration, or trial use. It can particularly relate to a dimension suitable for being arranged in a well of a microtiter plate such as a standard microtiter plate having 96 wells, 384 wells or 1536 wells. Such standard microtiter plates can be microtiter plates according to the standards developed by the Society for Biomolecular Screening (SBS) and approved by the American National Standards Institute (ANSI) are commonly used. These standards define microtiter plates of 127.76 mm length, 85.48 mm width and 14.35 mm height comprising 96, 384 or 1536 wells [see Society for Biomolecular Screening. ANSI/SBS 1-2004: Microplates—Footprint Dimensions, ANSI/SBS 2-2004: Microplates—Height Dimensions, ANSI/SBS 3-2004: Microplates—Bottom Outside Flange Dimensions and ANSI/SBS 4-2004: Microplates—Well Positions. http://www.sbsonline.org: Society for Biomolecular Screening, 2004.].

The body of the sample holder can be cup shaped. Thereby, the sidewall portion of it can be cylindrical or essentially cylindrical. The basis or basis area of the cylinder can have any suitable form such as a square, triangle or polygon. Advantageously, the cylinder is a circular cylinder. By having a circular cylindrical sidewall portion, the sample holder can comparably easily be handled. In particular, when being used in a multi-well plate as described in more detail below, a circular cylindrical sidewall portion can be advantageous. The dimension of the sidewall portion can be as desired in an intended application of the sample holder. For example, in embodiments where the size of the sidewall portion is comparably small in relation to the base area of the cylinder the body can be quasi disk-shaped. Or in the opposite, in embodiments where the size of the sidewall portion is comparably big in relation to the base area of the cylinder the body can be quasi post-like shaped.

By providing the bottom portion of the body of the sample holder in an at least partially amorphous material, i.e. TPI, X-ray can pass the sample holder through its bottom, typically top down. This allows for providing X-ray through the substance arranged inside the sample holder in transmission geometry (parallel or focusing beam) and through the bottom.

As used in many embodiments, e.g., of solid form screening processes X-ray diffractometry (XRD) or X-ray powder diffractometry (XPRD) are known methods for analyzing solid form properties of substances. In such embodiments, the at least partially amorphous bottom portion of the sample holder allows applying a transmission XRD or XPRD. For example, X-ray can be sent more or less axially through the sample holder and be detected adjacent the bottom outside the body. Thereby, the X-ray passes the substance as well as the bottom before arriving a detector. The detected X-ray can then be evaluated and conclusions to the properties of the substance can be drawn. Since no reflection from the sample carrier is originating the X-ray detection and evaluation can be comparably precise, simple and accurate. The TPI material can be quasi X-ray amorphous or at least partially X-ray amorphous and show only diffuse scattering of the X-ray beam.

More particularly, using the thermoplastic polyimide body allows for providing plural further essential benefits. For example, such material implies an insignificant or even no distortion of the X-ray such that the detected X-ray can be directly related to the substance. This can further improve the quality of evaluation of the detected and evaluated X-ray. Also, such material is more or less completely inert for many substances and does not influence the preparation process of the latter. This additionally helps for improving the quality of the X-ray evaluation. Further, such material is quasi completely tight under conditions in which crystallization and other experiments often are performed. Like this, safety of the system can comparably easily be established. Still further, sample holders of such material can efficiently and comparably low costly be manufactured. And still further, such material is also comparably robust and durable such that the substance can be processed and stored in the same single holder.

Thus, the sample holder according to the invention may provide a durable and cost efficient system allowing a high quality analysis of solid form properties of a substance and an efficient and safe processing of the substance.

Preferably, the body of the sample holder is essentially circular cylindrical. Such a shape of the holder allows for a precise transmission XRD or XRPD and a comparably simple handling particularly in a (semi-)automatic process. It allows for being arranged and processed in a microtiter plate such as a standard microplate. Furthermore, the circular cylindrical body allows for an efficient and accurate X-ray scanning of the substance being positioned in the interior. Still further, such a body can comparably efficiently be manufactured.

Preferably, the bottom portion of the body has a thickness of about 150 micrometer (μm) or less, of about 100 μm or less, of about 50 μm or less or of about 25 μm. Such a thickness of the bottom portion allows for providing a sufficient robustness as well as an interference-free or quasi interference-free transparency for X-ray radiation when the bottom is made of the TPI. Thus, such a bottom portion allows for performing transmission XRD or XRPD and, thereby, accurately and efficiently analyzing the solid form properties of the substance.

Preferably, in the interior of the body, the bottom portion and the sidewall portion form an essentially right angle. In this connection, the term “essentially right angle” can particularly cover angles which slightly deviate from 90°. For example, for allowing an efficient manufacturing it might be desired to have an angle which is not exactly 90°. The essentially right angle can be in a range of from 87° to 93°, from 88° to 92° or the like. Thereby, as described above, the body can essentially have the form of a right circular cylinder with a hollow interior, one closed end side, i.e., the bottom portion, and an open end side. The sidewall portion passing over into the bottom portion at a right angle allows for efficiently accessing the substance in the interior. For example, such an arrangement allows for pushing the substance to the bottom portion in order to making it efficiently accessible to the X-ray, e.g., by means of a rod accessing the interior or the like.

Preferably, the sidewall portion of the body has a protruding section in which an outer diameter of the sidewall portion exceeds an outer diameter of the sidewall portion outside the protruding section. Such a protruding section allows for efficiently handling the sample holder. For example, it allows for precisely and efficiently grabbing the holder and/or placing the holder in a well of a multi-well plate. Thereby, the protruding section of the sidewall portion preferably forms a lower step. Such a lower step can form an abutting surface for exactly positioning the holder, e.g., in a well of a microtiter plate. Also, it preferably forms an upper step. Such an upper step allows for efficiently positioning any part such as a cap or the like onto the holder.

Preferably, the sidewall portion of the body has a thickness in a range of between about 400 μm and about 1500 μm, of between about 600 μm and about 1200 μm or of between about 700 μm and about 1000 μm. Such dimensions of the sidewall portion allow for providing a sufficient robustness. Also it can comparably easily be manufactured, for example in an injection molding process or an injection molding embossing process. Thereby, the thickness of the protruding section of the sidewall portion of the body preferably is about 400 μm to about 200 μm bigger than outside the protruding section. Such a thickness allows for efficiently providing the protruding section with its preferred properties.

Preferably, the sample holder comprises a cap adapted to be arranged on the body to close the interior of the body. The cap can particularly be arranged on the sidewall portion at a side opposite to the bottom portion. Such a cap allows for efficiently closing the holder. Particularly, the body of the holder can be tightly closed such that the system can provide an accurate safety.

Thereby, the cap preferably is made of a TPI such as the same material as the body. Like this, the X-ray can be provided linearly through the cap as well as through the bottom portion of the body. This allows for processing the holder in a transmission XRD or XPRD application when the sample holder is closed.

The cap preferably has a first mating structure and the body preferably has a second mating structure, wherein the first mating structure pressure-fits the second mating structure when the cap closes the body. The term “pressure fit” as used herein can relate to cap which tightly connects to the body while being under an elevated pressure, only. It can further relate to a cap which tightly connects after being applied to the body with pressure. For example, the cap can be clamped on the body when closing the same.

Another aspect of the invention relates to a multi-well plate having a plurality of wells, characterized in that each of the plurality of wells has a bottom made of a thermoplastic polyimide, wherein the wells are shaped to receive and hold a sample holder as described above.

The multi-well plate can have any suitable number of wells such as, e.g., 24 or 48 wells. It can particularly be a standard microplate as described above.

Using such multi-well plate it can advantageously be equipped with one of more sample holders. Like this, the sample holder and a substance arranged therein can efficiently be processed. In particularly, the multi-well plate allows for efficiently being processed to screen solid form of the substance by X-ray diffractometry (XRD) or X-ray powder diffractometry (XPRD). Thereby, the multi-well plate can be manufactured in any appropriate material, such as aluminum, which material has not to be adapted or chosen to the substance. Furthermore, handling of the substance inside the sample holder can be particularly efficient and convenient. It can be held in the sample holder during several steps in a process wherein, if desired, the sample holder together with the substance can be removed from the multi-well plate. Also the sample holder can be a single use entity whereas the other parts of the multi-well plate can be reused.

Thus, the multi-well plate allows for providing a high quality analysis of solid form properties of a substance and an efficient and safe processing of it. Particularly, it also allows the process to be (semi-)automatic and to use laboratory or other equipment suitable for standard microplates.

A further other aspect of the invention relates to a method of analyzing solid form properties of a substance comprising the step of solidifying the substance. The method comprises the further steps of: obtaining the solidified substance in one of the wells of a multi-well plate as described above and analyzing the solidified substance in the well of the multi-well plate by transmission X-ray diffraction. The analyzing step comprises providing X-ray from a top of the well through the solidified substance and a bottom of the well and evaluating the X-ray which passed the solidified substance and the bottom of the well.

In this context, the term linearly relates to providing the X-ray along a line which can be essentially straight.

The method according to the invention allows for efficiently implementing the effects and benefits described above in connection with the sample holder, the multi-well plate and their preferred embodiment.

Preferably, the method comprises mixing a powder or other solid and a solvent or other reagent such that a solution of the substance results. Thereby, the powder or other solid and the solvent or reagent preferably are mixed in the sample micro-vessel. Like this, preparation of sample can efficiently be implemented, wherein dissolution is not required to be complete for a solution mediated solid form transformation.

Preferably, the method comprises closing the top of the well of the multi-well plate with a cap or a foil made of a thermoplastic polyimide before the solidified substance is analyzed. Like this, the substance as well as the environment around the micro-vessel can be protected during the process or at least certain steps thereof.

Preferably, the method comprises microscopic measuring the solidified substance in the well of the multi-well plate. Such microscopic measurement can provide additional information about the solidified substance. This can increase the quality of the analysis of the solidification.

Preferably, the method comprises drying the solidified substance in the at least one well of the multi-well plate. Thereby, it preferably additionally comprises analyzing the solidified substance in the well of the multi-well plate by transmission X-ray diffraction before drying the solidified substance. Also, it preferably additionally or alternatively comprises analyzing the solidified substance in the well of the multi-well plate by transmission X-ray diffraction after drying the solidified substance. Such analysis before and after the drying step can provide important further information about the behavior of the solidified substance.

Preferably, the sample holder is stored in a storage multi-well plate. Such storing allows for reproducing and further evaluating the substance and the analysis thereof.

### BRIEF DESCRIPTION OF THE DRAWINGS

The sample holder and the process according to the invention are described in more detail herein below by way of exemplary embodiments and with reference to the attached drawings, in which:

FIG. 1 shows a top view on a body of an insert as a first embodiment of a sample holder according to the invention;

FIG. 2 shows a cross sectional view of the body of FIG. 1 along the line A-A of FIG. 1;

FIG. 3 shows a top view on a cap of the sample micro-vessel of FIG. 1;

FIG. 4 shows a cross sectional view of the cap of FIG. 3 along the line B-B of FIG. 3;

FIG. 5 shows a side and partially cross sectional view of the sample micro-vessel of FIG. 1;

FIG. 6 shows detail C of FIG. 5;

FIG. 7 shows detail D of FIG. 5;

FIG. 8 shows an exploded perspective view of an embodiment of a multi-well plate according to the invention equipped with inserts identical to the inserts of FIG. 1 to FIG. 7 in a preparing arrangement;

FIG. 9 shows an exploded side view of the multi-well plate of FIG. 8;

FIG. 10 shows a top view of the multi-well plate of FIG. 8;

FIG. 11 shows a cross sectional view of the multi-well plate of FIG. 8 along the line E-E of FIG. 10;

FIG. 12 shows detail F of FIG. 11;

FIG. 13 shows an exploded side view of the multi-well plate of FIG. 8 in an analyzing arrangement;

FIG. 14 shows a cross sectional view of the multi-well plate of FIG. 13 along the line E-E of FIG. 10;

FIG. 15 shows detail G of FIG. 14;

FIG. 16 shows a cross sectional view of the body of FIG. 1 equipped with a stopper;

FIG. 17 shows a cross sectional view of a second embodiment of a sample holder according to the invention;

FIG. 18 shows a cross sectional view of a third embodiment of a sample holder according to the invention; and

FIG. 19 shows a graphic of the background characteristics of thermoplastic polyimide compared to a conventional polyimide, i.e. poly (4,4′-oxydiphenylene-pyromellitimide).

### DESCRIPTION OF EMBODIMENTS

In the following description certain terms are used for reasons of convenience and are not intended to limit the invention. The terms “right”, “left”, “up”, “down”, “under” and “above” refer to directions in the figures. The terminology comprises the explicitly mentioned terms as well as their derivations and terms with a similar meaning. Also, spatially relative terms, such as “beneath”, “below”, “lower”, “above”, “upper”, “proximal”, “distal”, and the like, may be used to describe one element's or feature's relationship to another element or feature as illustrated in the figures. These spatially relative terms are intended to encompass different positions and orientations of the devices in use or operation in addition to the position and orientation shown in the figures. For example, if a device in the figures is turned over, elements described as “below” or “beneath” other elements or features would then be “above” or “over” the other elements or features. Thus, the exemplary term “below” can encompass both positions and orientations of above and below. The devices may be otherwise oriented (rotated 90 degrees or at other orientations), and the spatially relative descriptors used herein interpreted accordingly. Likewise, descriptions of movement along and around various axes includes various special device positions and orientations.

To avoid repetition in the figures and the descriptions of the various aspects and illustrative embodiments, it should be understood that many features are common to many aspects and embodiments. Omission of an aspect from a description or figure does not imply that the aspect is missing from embodiments that incorporate that aspect. Instead, the aspect may have been omitted for clarity and to avoid prolix description. In this context, the following applies to the rest of this description: If, in order to clarify the drawings, a figure contains reference signs which are not explained in the directly associated part of the description, then it is referred to previous or following description sections. Further, for reason of lucidity, if in a drawing not all features of a part are provided with reference signs it is referred to other drawings showing the same part. Like numbers in two or more figures represent the same or similar elements.

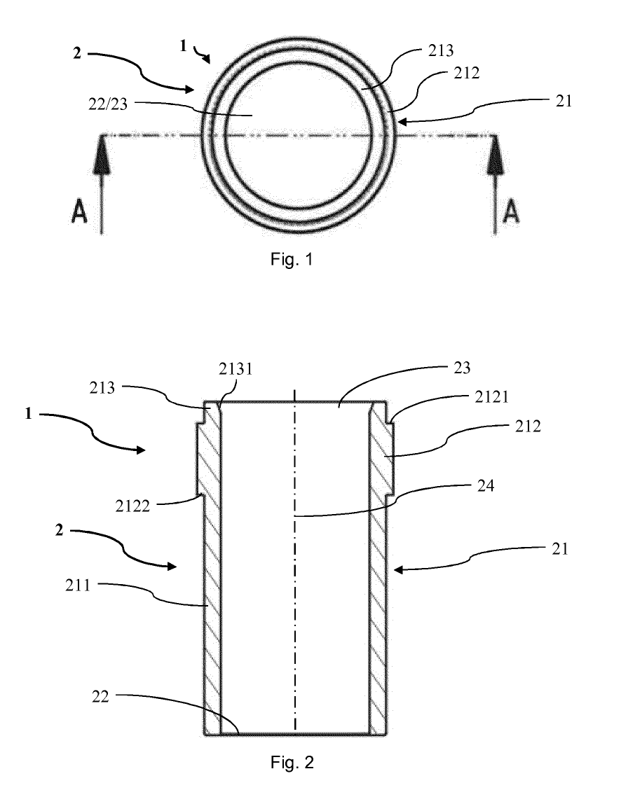

FIG. 1 shows a top view of a body 2 of an insert 1 as a first embodiment of a sample holder according to the invention. The body 2 has a right circular sidewall portion 21 and a flat circular bottom portion 22. The sidewall portion 21 has an upper cap receiving section 213 and a protruding section 212 radially extending beyond the cap receiving section 213.

In FIG. 2 the body 2 is shown in a cross sectional side view. Thereby, it can be seen that the body 2 has an interior and that the bottom portion 22 is essentially perpendicular to the sidewall portion 21. At its inner side, the sidewall portion 21 is straight. Thus, in the interior of the body 2, the bottom portion 22 and the sidewall portion 21 form an essentially right angle.

The sidewall portion 21 further has a pipe like lower section 211. The protruding section 212 of the sidewall portion 21 laterally projects over the lower section 211 and the cap receiving section 213 to an identical extent. More particular, the lower section 211 abruptly passes over into the protruding section 212 thereby forming a lower step 2122 at the bottom end of the protruding section 212. Similarly, the cap receiving section 213 abruptly passes over into the protruding section 212 thereby forming an upper step 2121 at the top end of the protruding section 212. The lower step 2122 and the upper step 2121 each have a horizontal abutting surface wherein the abutting surface of the lower step 2122 is downwardly oriented and the abutting surface of the upper step 2121 is upwardly oriented.

The entire body 2 is rotational symmetric around a longitudinal axis 24. It is completely made of a preferably amorphous thermoplastic polyimide (TPI). The protruding section 212 is embodied in the sidewall portion 21 by varying its thickness in an axial direction. For example, in the embodiment shown in FIG. 1 and FIG. 2, a thickness of the sidewall portion 21 is 1 millimeter (mm) in the protruding section 212 and 0.7 mm outside the protruding section 212, i.e., in the cap receiving section 213 and the lower section 211. Thus, the protruding section 212 laterally projects over the lower section 211 and the cap receiving section 213 by 0.3 mm.

As can be seen in FIG. 2, the bottom portion 22 is comparably thin, for example, 0.05 mm thick. At its top end the body 2 has a free opening 23 wherein in the upper part of the cap receiving section 213 the interior is slightly expanding. Thus, the inner surface of the sidewall portion 21 has an outwardly tapering part 2131 at the opening 23. For example, the height of the body 2 amounts to about 14 mm wherein the cap receiving section 213 is about 0.9 mm thereof and the protruding section is about 3 mm thereof. The inner diameter of the body 2 is, e.g., about 6.25 mm and the outer diameter is about 8.25 mm at the protruding section 213 and about 7.4 mm outside the protruding section 213.

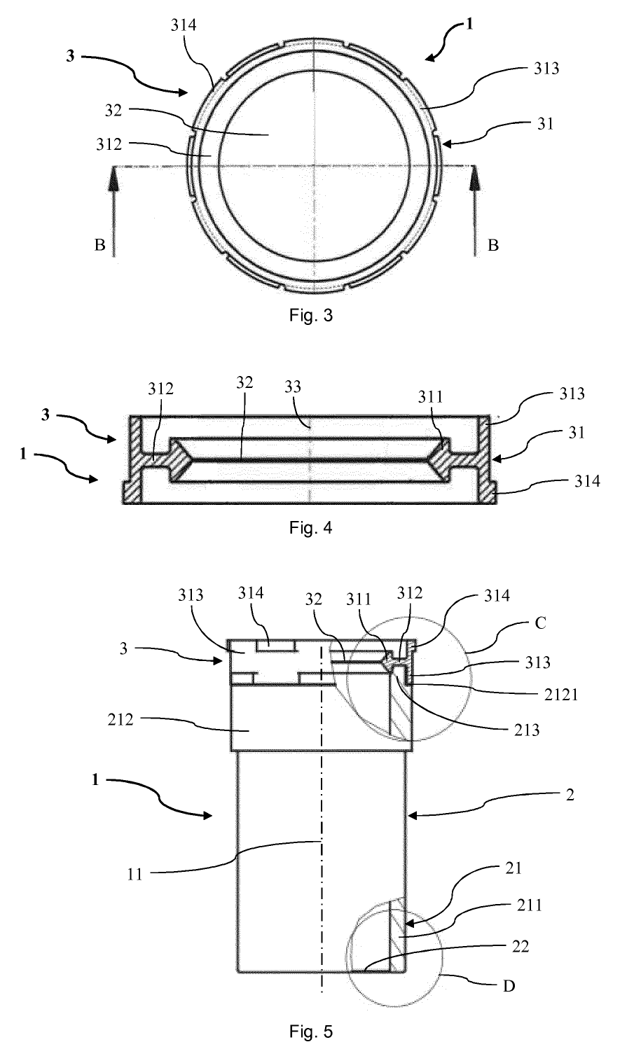

FIG. 3 shows a top view of a cap 3 of the insert 1. The cap 3 has a sidewall portion 31 surrounding a circular window portion 32. The sidewall portion 31 has a right circular cylinder section 313 and plural gripping projections 314 outwardly extending from the cylinder section 313 at various heights. It further, includes a radial section 312 inwardly extending from the cylinder section 313.

In FIG. 4 the cap 3 is shown in a cross sectional side view. Thereby, it can be seen that the radial section 312 of the sidewall portion 31 of the cap 3 perpendicularly extends from the interior surface of its cylinder section 313. Thus, it horizontally extends. At its inner end, the radial section 312 passes over into an inwardly narrowing arrow section 311 which directly surrounds the window portion 32.

The entire cap 3 is one piece made of the TPI which is also used in the body 2. It has a vertical axis 33. The window portion 32 is comparably thin, for example, it has a thickness of about 0.05 mm. The whole cap has a height of about 2 mm, for example. An inner diameter of the cylinder section 313 of the sidewall portion 31 corresponds to the outer diameter of the cap receiving section 213 of the sidewall portion 21 of the body 2. For example, it is about 7.8 mm which is about 0.2 mm bigger than the outer diameter of the cap receiving section 213. Since the arrow section 311 at its lateral end side is higher than the radial section 312 it axially or vertically projects over the radial section 312 in an upward and downward direction. Thereby, the outer side of the arrow section 311 forms together with the top and bottom sides of the radial section 312 and the inner side of the cylinder section 313 a body recess.

FIG. 5 shows the complete insert 1 wherein the cap 3 is mounted onto the body 2. The axis 24 of the body 2 together with the axis 33 of the cap 3 form an axis 11 of the insert 1. Thereby, the cap receiving section 213 of the sidewall portion 21 of the body 2 is arranged in the body recess of the cap 3. In more detail, the top end of the cap receiving section 213 abuts the bottom side of the radial section 312 of the sidewall portion 31 of the cap 3 and the upper step 2121 of the protruding section 212 of the sidewall portion 21 of the body 2 abuts the bottom end of the cylinder section 313 of the sidewall portion 31 of the cap 3.

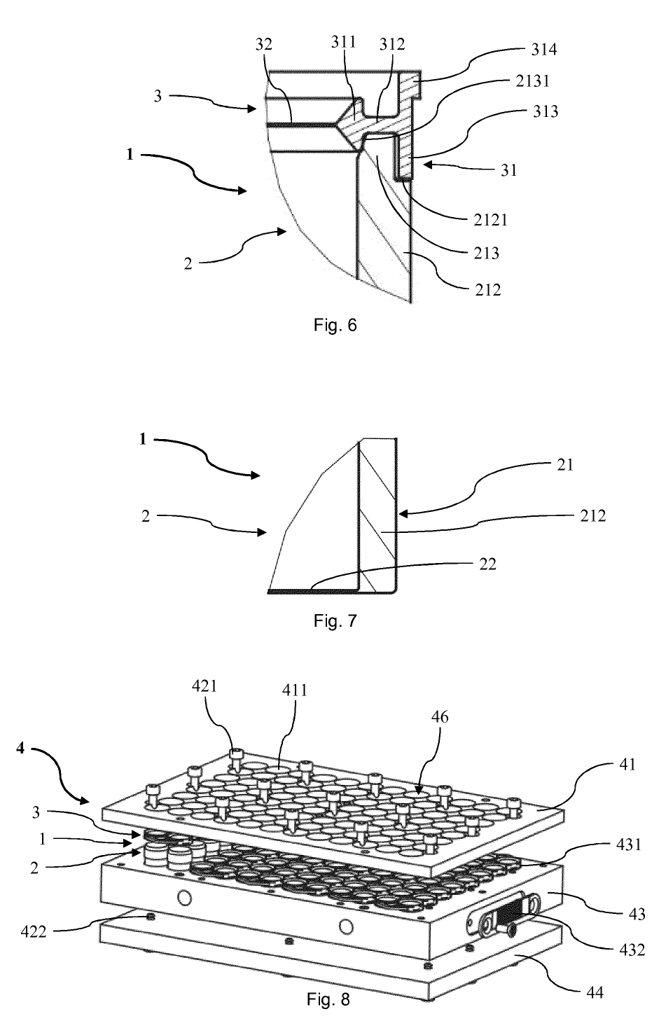

In FIG. 6 and FIG. 7 sections of the insert 1 are shown in more detail. Thereby, it can be seen that the vertical outer side of the arrow section 311 of the cap 3 abuts the tapering part 2131 of the inner surface of the sidewall portion 21. When the cap 3 and the body 2 are pressed together, the arrow section 311 slides along the inclined surface of the tapering part 2131 such that the cap 3 or a specific section thereof is slightly deformed. Like this, the cap 3 can tightly close the body 2.

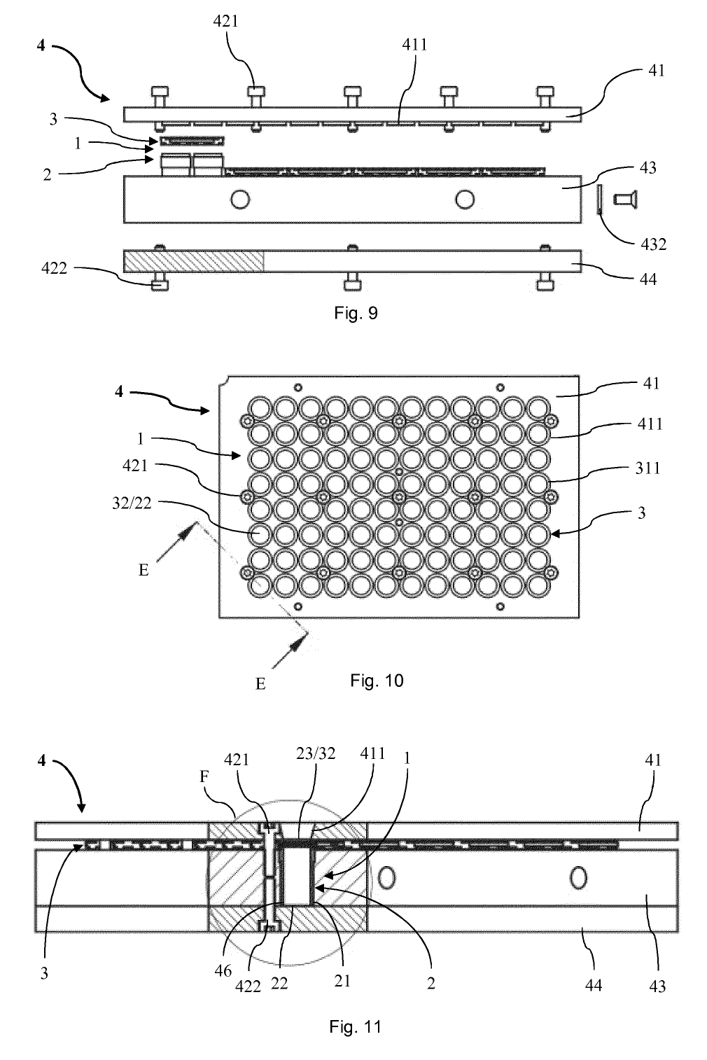

FIG. 8 and FIG. 9 show an embodiment of a multi-well plate 4 according to the invention. The multi-well plate 4 comprises a cover plate 41, a main plate 43 and, in the preparing arrangement of the multi-well plate shown in FIGS. 8-12, a solid plate 44. The main plate 43 is equipped with a label 432 mounted to a cross side. The solid plate 44 is screwed bottom up to the main plate 43 by means of screws 422. Then the cover plate 41 is screwed top down to the main plate 43 by means of screws 421.

As can be best seen in FIG. 10, the multi-well plate 4 has ninety-six wells 46 formed by bores in the cover plate 41 and bores in the main plate 43. The wells 46 are arranged in eight rows each having twelve wells 46. Turning back to FIG. 8 and FIG. 9, each well 46 has one insert 1 wherein the bottom portion 22 of the body 2 of the insert 1 forms the bottom of the well 46. Thus, the bottoms 22 of the wells 46 are made of the preferably amorphous thermoplastic polyimide. Each of the bodies 2 is provided with one cap 3 of the insert 1 wherein the caps 3 are grouped to handling units having two rows each with eight caps 3 connected together.

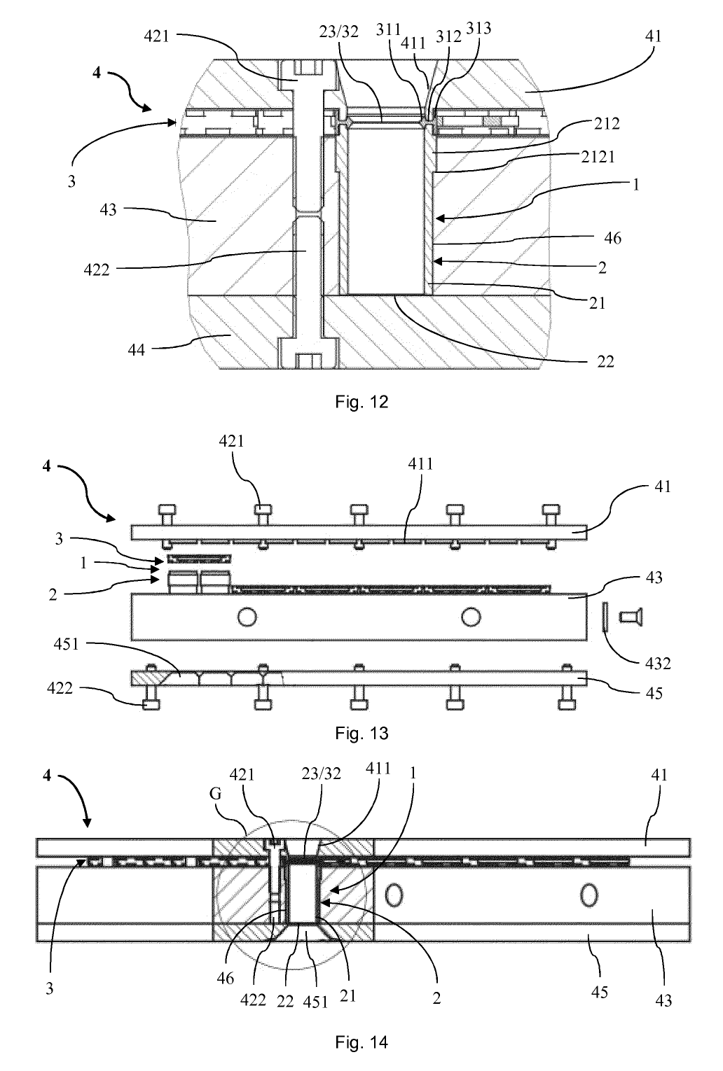

As can be seen in FIG. 11 and FIG. 12 in more detail each of the bores in the main plate 43 is shaped to receive and hold one of the inserts 1. In the main plate 43 the wells 46 have dimensions fitting to the inserts 1. Particularly, the inner surfaces of the wells 46 are adapted to mate to the outer surfaces of the inserts 1. In more detail, the wells 46 in the main plate 43 have widened upper ends to receive the protruding sections 212 of the bodies 2 of the inserts 1. Thereby, the widened upper ends have horizontal contact surfaces which abut the lower surfaces 2121 of the protruding sections 212.

In the cover plate 41 the bores forming the wells 46 are downwardly tapering. In particular, in the cover plate 41 the wells 46 have inclined inner side surfaces 411 which form a conus angle of about 30°. Such conical shape gives space to X-ray irradiation. Furthermore, the cover plate 41 presses the caps 3 on the bodies 2 such that the inserts 1 are tightly closed.

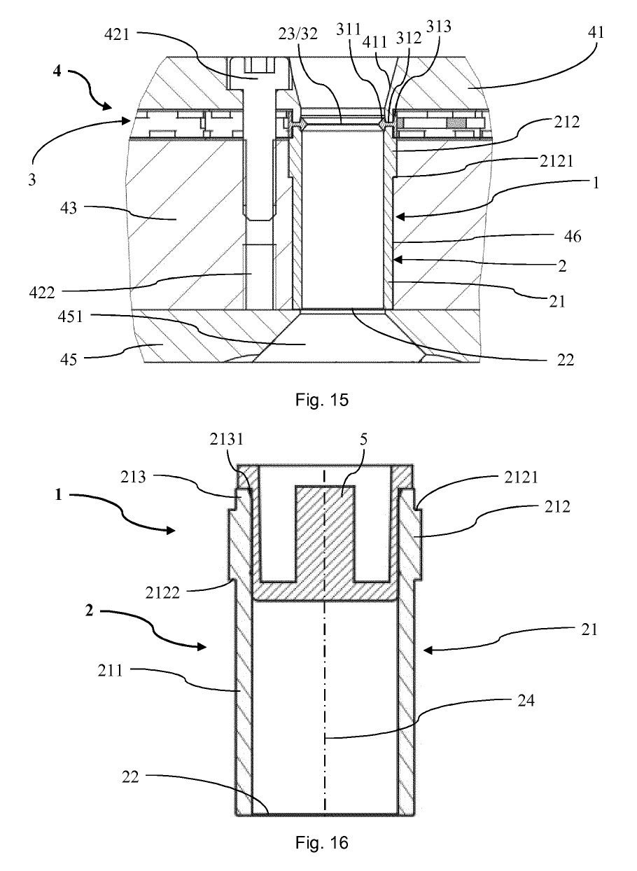

In contrast to FIGS. 8-12, in which the multi-well plate is shown in a preparing arrangement, FIGS. 13-15 show the multi-well plate 4 in an analyzing arrangement. In particular, instead of the solid plate 43 an aperture plate 45 is screwed bottom up to the main plate 43 by means of the screws 422. The aperture plate 45 comprises a plurality of conical bores 451 which are downwardly widening. The bores 451 are arranged at the aperture plate 45 such that each well 46 is equipped with one of the bores 451.

The multi-well plate 4 can specifically be used for analyzing solid form or crystallization properties of substances in an embodiment of a method according to the invention. Thereby, for preparing the substances powders, solvents and reagents are provided into the bodies 2 of the inserts 1 which are positioned in the wells 46 of the multi-well plate 4 in its preparing arrangement. More particularly, the solid plate 44 is screwed bottom up to the main plate 43 and the bodies 2 of the inserts 1 are positioned top down into the wells 46. Then, the powders and solvents are provided into the bodies 2 and the caps 3 are placed onto the bodies 2. Finally, the cover plate 41 is screwed top down to the main plate 43 such that the caps 3 are pressed onto the bodies 2 and, thereby, the inserts 1 are tightly closed.

Inside the inserts the powder and the solvent are mixed and prepared such that the substances result in a solid form. For example, the substances can be crystallized inside the inserts 1. Such preparing may include equilibration for example by the help of a stirrer, cooling, anti-solvent addition, lyophilizing, reactive crystallization, precipitation or evaporation.

After solidification or preparation, the solid plate 44 is replaced by the aperture plate 45 resulting in the multi-well plate 4 being in its analyzing arrangement. Then, the moist solidified substances are analyzed by transmission X-ray diffraction. In particular, an X-ray beam is provided from an appropriate source above the cover plate 41 into the wells 46 and inserts 1 through the solidified substances and the bottoms 22 and out of the bores 451 of the aperture plate 45. For allowing to completely illuminate the whole wells 46 by the X-ray beam having a line focus, the multi-well plate 4 is rotated (+/−approx. 180°). To further reduce statistical effects on the intensity distribution the wells 46 are tilted to a max. of 15° during the measurement. As mentioned above, the inclined surfaces 411 of the bores of the cover plate 41 allow for preventing to shade the wells 46.

Below the multi-well plate 4 a detector is arranged which detects the X-ray passing the bottoms 22 of the wells 46. The detected X-ray is then evaluated and conclusions about the solid form properties of the solidified substances are drawn. Additionally, the moist crystallized substances inside the inserts 1 are microscopically measured for gathering further information.

Then, the system is prepared for a drying step which includes removing the caps 3 from the bodies 2 for allowing evaporation. The crystallized substances are dried and the caps 3 are mounted to the bodies again. Thereafter, the dried solid substances are analyzed by transmission X-ray diffraction and microscopic inspection again.

After analyzing the substances, the inserts 1 can be rearranged in accordance with the results of the analysis. As shown in FIG. 16 the inserts 1 are then tightly closed. In particular, the caps 3 are removed from the bodies 2 and, instead, elastic stoppers 5 are pressed top in the bodies 2. Like this, the inserts 1 are tightly closed. Then, the inserts 1 are positioned in a storage multi-well plate where they can be stored.

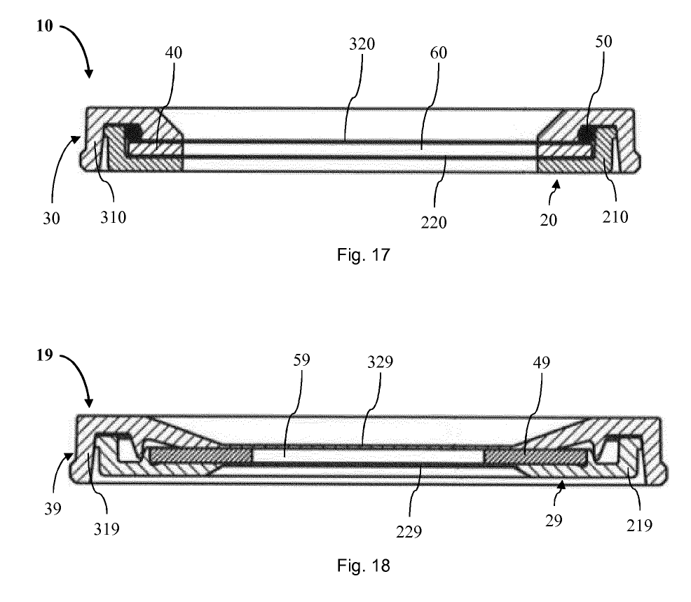

FIG. 17 shows a cross-sectional view of a sample carrier 10 as a second embodiment of a sample holder according to the invention. The sample carrier 10 has a body 20 and a cap 30. The body 20 comprises an L-shaped sidewall portion 210 and a circular bottom portion 220. The bottom portion 220 is positioned on a horizontal section of the sidewall portion 210. It is made of a preferably amorphous TPI.

The cap 30 of the sample carrier 10 has a sidewall portion 310 surrounding a circular window portion 320. The window portion 320 is made of the preferably amorphous TPI. The sidewall portion 310 is hook-shaped wherein a vertical section of the sidewall portion 210 of the body 20 is received in the hook. Between the horizontal section of the sidewall portion 210 of the body 20 and a central section of the sidewall portion 310 of the cap 30 a ring shaped spacing screen 40 is arranged. A through hole of the spacing screen 40 is limited by the bottom portion 220 of the body 20 and the window portion 320 of the cap 30 such that an interior 60 is formed in between.

Between the sidewall portion 210 of the body 20, the sidewall portion 310 of the cap 30 and the spacing screen 40 an O-ring 50 is clamped which seals the interior 60 of the sample carrier 10.

In FIG. 18 another sample carrier 19 as a third embodiment of a sample holder according to the invention is shown. The sample carrier 19 has a body 29 and a cap 39. The body 29 comprises a partially L-shaped sidewall portion 219 and a circular bottom portion 229. The sidewall portion 219 and the bottom portion 229 are one piece made of a preferably amorphous TPI.

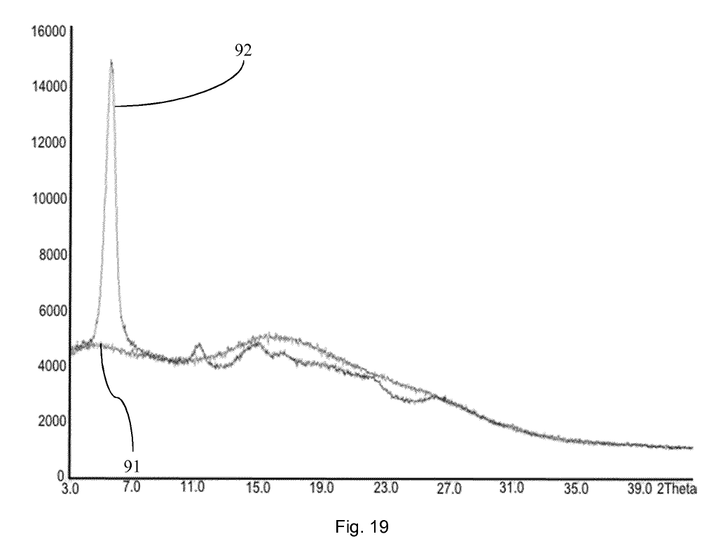

The cap 39 of the sample carrier 19 has a sidewall portion 319 surrounding a circular window portion 329. The sidewall portion 319 and the window portion 329 are one piece made of the preferably amorphous TPI. The sidewall portion 319 is partially hook-shaped wherein a vertical section of the sidewall portion 219 of the body 29 is received in the hook. Between a horizontal section of the sidewall portion 219 of the body 29 and a central arm section of the sidewall portion 319 of the cap 39 a flat sealing ring 49 is arranged. Between the bottom portion 229 of the body 29, the window portion 329 of the cap 39 and the sealing ring 49 an interior 59 of the sample carrier 19 is formed. FIG. 19 shows graphs of measurement results of the background characteristics of thermoplastic polyimide (TPI) and of poly (4,4′-oxydiphenylene-pyromellitimide) which is known in the art under the trademark Kapton. More particularly, in the example shown in FIG. 19 background properties of a 0.13 mm thick foil made of TPI are compared to background properties of a 0.125 mm thick foil made of Kapton. Thereby, the TPI graph 91 and a Kapton graph 92 result each showing the measurement results of the respective foil.

As can be derived from FIG. 19 the TPI foil is X-ray amorphous and shows no characteristic peaks as Kapton foil does. Due to the absence of such broad peaks in comparison to Kapton foil, the TPI foil is essentially better suitable for analytical applications. In addition, it consists of the same low X-ray background properties comparable to Kapton foil and also provides the same good stability properties for preparation/protection purposes for analytical testing.

This description and the accompanying drawings that illustrate aspects and embodiments of the present invention should not be taken as limiting—the claims defining the protected invention. In other words, while the invention has been illustrated and described in detail in the drawings and foregoing description, such illustration and description are to be considered illustrative or exemplary and not restrictive. Various mechanical, compositional, structural, electrical, and operational changes may be made without departing from the spirit and scope of this description and the claims. In some instances, well-known circuits, structures and techniques have not been shown in detail in order not to obscure the invention. Thus, it will be understood that changes and modifications may be made by those of ordinary skill within the scope and spirit of the following claims. In particular, the present invention covers further embodiments with any combination of features from different embodiments described above and below.

The disclosure also covers all further features shown in the Figs. individually although they may not have been described in the afore or following description. Also, single alternatives of the embodiments described in the figures and the description and single alternatives of features thereof can be disclaimed from the subject matter of the invention or from disclosed subject matter. The disclosure comprises subject matter consisting of the features defined in the claims or the exemplary embodiments as well as subject matter comprising said features.

Furthermore, in the claims the word “comprising” does not exclude other elements or steps, and the indefinite article “a” or “an” does not exclude a plurality. A single unit or step may fulfil the functions of several features recited in the claims. The mere fact that certain measures are recited in mutually different dependent claims does not indicate that a combination of these measures cannot be used to advantage. The terms “essentially”, “about”, “approximately” and the like in connection with an attribute or a value particularly also define exactly the attribute or exactly the value, respectively. The term “about” in the context of a given numerate value or range refers to a value or range that is, e.g., within 20%, within 10%, within 5%, or within 2% of the given value or range. Components described as coupled or connected may be electrically or mechanically directly coupled, or they may be indirectly coupled via one or more intermediate components. Any reference signs in the claims should not be construed as limiting the scope.

1. A sample holder for containing a substance in a solid form screening process, comprising:
a body with a sidewall portion, a bottom portion and a hollow interior limited by the sidewall portion and the bottom portion, wherein the bottom portion is made of a thermoplastic polyimide.

2. The sample holder according to claim 1, wherein the sidewall portion and the bottom portion are one single piece made of the thermoplastic polyimide.

3. The sample holder according to claim 1, wherein the body is essentially circular cylindrical.

4. The sample holder according to claim 1, wherein the bottom portion of the body has a thickness of about 150 micrometer or less, of about 100 micrometer or less, of about 50 micrometer or less, or of about 25 micrometer.

5. The sample holder according to claim 1, wherein in the interior of the body the bottom portion and the sidewall portion form an essentially right angle.

6. The sample holder according to claim 1, wherein the sidewall portion of the body has a protruding section in which an outer diameter of the sidewall portion exceeds an outer diameter of the sidewall portion outside the protruding section.

7. The sample holder according to claim 6, wherein the protruding section of the sidewall portion forms a lower step.

8. The sample holder according to claim 6, wherein the protruding section of the sidewall portion forms an upper step.

9. The sample holder according to claim 1, wherein the sidewall portion of the body has a thickness in a range of between about 400 micrometer and about 1500 micrometer, of between about 600 micrometer and about 1200 micrometer, or of between about 700 micrometer and about 1000 micrometer.

10. The sample holder according to claim 6, wherein the sidewall portion of the body has a thickness in a range of between about 400 micrometer and about 1500 micrometer, of between about 600 micrometer and about 1200 micrometer, or of between about 700 micrometer and about 1000 micrometer, and wherein the thickness of the protruding section of the sidewall portion of the body is about 400 micrometer to about 200 micrometer bigger than outside the protruding section.

11. The sample holder according to claim 1, comprising a cap adapted to be arranged on the body to close the interior of the body.

12. The sample holder according to claim 11, wherein the cap is made of the thermoplastic polyimide.

13. The sample holder according to claim 11, wherein the cap has a first mating structure and the body has a second mating structure (213), wherein the first mating structure (311, 312, 313) pressure-fits the second mating structure (213) when the cap (3; 30; 39) closes the body (2; 20; 29).

14. A multi-well plate having a plurality of wells, wherein each of the plurality of wells has a bottom made of a thermoplastic polyimide, wherein the wells are shaped to receive and hold a sample holder according to claim 1.

15. A method of analyzing solid form properties of a substance, comprising
solidifying the substance,
obtaining the solidified substance in one of the wells of the multi-well plate according to claim 14, and
analyzing the solidified substance in the well of the multi-well plate by transmission X-ray diffraction comprising
providing X-ray from a top of the well through the solidified substance and a bottom of the well, and
evaluating the X-ray which passed the solidified substance and the bottom of the well.
